(19) United States
(12) Patent Application Publication
(10) Pub. No.: US 2011/0233925 A1
(43) Pub. Date: Sep. 29, 2011

(54) THREADED JOINT WITH ELASTOMERIC SEAL FLANGE

(75) Inventors: Giuseppe Della Pina, Treviolo (IT); Stefano Ravanelli, Bologna (IT)

(73) Assignee: TENARIS CONNECTIONS LIMITED, Kingstown (VC)

(21) Appl. No.: 13/072,533

(22) Filed: Mar. 25, 2011

(30) Foreign Application Priority Data
Mar. 25, 2010 (EP) 10157693.2

(51) Int. Cl. F16L 25/00; F16L 23/00

(52) U.S. Cl. 285/333; 285/363

(57) ABSTRACT

A threaded joint has a seal flange or device in order to avoid the seepage of external pressure of fluid inside the pipe. The sealing flange has an L-shape and is interposed in a housing between a pin and a box, and the flange-like annular portion of the flange helps to verify proper positioning of the flange during make-up and contributes to increase tightness of the joint because the external fluid pressure improves adherence of the sealing flange against the contact surfaces of the joint.

### CROSS-REFERENCE TO RELATED APPLICATIONS

This application claims priority to European Patent Application No. EP 10157693.2, titled “THREADED JOINT WITH ELASTOMERIC SEAL FLANGE,” filed Mar. 25, 2010, the entirety of which is hereby incorporated by reference.

### BACKGROUND

1. Field

The present invention relates to threaded joints, in particular for connecting tubes of commercial length to make strings of appropriate length used in the hydrocarbon industry, especially for use in wells for exploiting hydrocarbon fields.

2. Background

Searching for oil or more generally hydrocarbons has become more demanding in terms of hardware and devices in recent years because oil and gas fields or reservoirs are located deeper or in places more difficult to reach than in the past and below the sea bottom. Prospecting for and exploitation of hydrocarbon fields makes it necessary to use hardware in environments where the external pressure of fluid, e.g., marine water, may create a seepage through the connection into the pipe itself. A need for improving the sealing ability of the joints is generally felt and various types of seals have been developed.

Threaded joints are generally provided with metal-to-metal seals generated by the contact between two surfaces, usually placed at one or at both ends of the threaded portions of a pin and a box, interfering in the elastic range of the modulus of elasticity for an appropriate stress magnitude. However in specific applications, resilient seals are needed instead of or in combination with metallic seals, to better prevent penetration of external fluids in the interstices of the threads and, worse, within the pipe itself.

Some documents disclose elastomeric sealing rings, e.g., U.S. Patent Application Publication No. 2006/0006600, International Patent Application Publication Nos. W002/068854 and W002/29290, and Japanese Patent Application Publication No. JP07-139666. However the seals disclosed in these documents still leave an unresolved operative problem during joint assembly.

The so-called mill-end of the threaded joint is assembled at the mill with precision, because there is enough time and tooling to ensure proper positioning of the sealing rings. On the contrary, the so-called field end needs to be assembled and made-up in the rig, with many technical limitations. The presence of an additional element, namely a sealing ring, adds complexity to the running operation. In many cases, operators have no indication on whether the sealing ring is properly placed. Wrong positioning or assembling of the sealing ring in its seat can lead to a failure in its sealing function, which could lead to a failure of the whole joint, e.g., by loss of liquid or of gas tightness, or by corrosion.

Sealing rings of the prior art are designed to be completely housed in a space between the pin and the box and the space to house them can be shaped as grooves machined in the threaded portion of the joint. This solution may create make-up problems, including the possible extrusion of the seal ring in the thread with detriment to the accuracy of the make up and to the tightness of joint. In some cases the sealing rings can be housed within a cavity made internally between the pin and box by partly excavating the walls of the pin and box. This solution, while it provides the advantage of protecting the sealing ring from mechanical damages during make up, makes it difficult for the operator to check if the sealing ring has reached a correct positioning.

### SUMMARY

In some embodiments, a threaded joint is provided which overcomes the aforementioned drawbacks with an innovative annular seal flange that ensures a simple and secure initial make-up operation, a high sealing efficiency during operation, and a visual indication of the position of the sealing flange.

In some embodiments, the threaded joint comprises an axis, a male tube comprising a pin with external male threads, a female tube comprising a box with internal female threads, and a sealing flange. The pin can be adapted to be made up in the box. A housing can be provided between an external surface of the pin and an internal surface of a nose of the box. The sealing flange can comprise a first annular portion proximal to the box threads and a second annular portion distal to the box threads. The housing can be configured to accommodate the first annular portion of the sealing flange and the second annular portion can be configured to abut an end surface of the box nose.

Features that advantageously contribute to the improvement of the threaded joint include, for example, the annular portion of the flange that protrudes out from the end of box member and is distal with respect to the joint threading, and which constitutes an indicator that the whole annular sealing flange is properly positioned. Another feature includes the proximal annular portion of smaller radius than the distal annular portion, which advantageously ensures good positioning and improved tightness.

In some embodiments of the sealing flange, annular protrusions are located in the internal and/or external surfaces of the proximal annular portion and provide increased tightness in particular uses of the threaded joint where higher external pressures are in play. These annular protrusions, in the presence of a wrapping force equal to that commonly used for state of the art rings, can produce a concentration of the stresses and higher localized contact pressures caused by the compression of the sealing flange between the pin and box, which further enhances sealability of the joint.

In some embodiments, the joint can also provide a metal-to-metal sealing surface, placed, e.g., at the end of the pin near the annular abutment shoulder at the internal surface of a coupling (or, more in general, the box).

The sealing flange of the embodiments disclosed herein can advantageously be pre-inserted onto the pin, thus avoiding damage of the sealing ring itself during make-up, subsequently the pin can be inserted into the box and made-up.

The sealing flange of the embodiments disclosed herein advantageously ensures tightness to the external pressure to the joint, even when one of the other sealing functions might singularly be overcome by the external fluid. After make-up is completed, the proximal annular portion of the sealing flange is retained in the annular housing defined between the inner surface of the box and the outer surface of the pin. The external fluid pressure further increases the retaining forces on the whole sealing ring.

In some embodiments, the surface of this housing can also be provided with a finishing and/or a coating layer, if desired. The coating can protect the machined surface of both the pin and box. The housing geometry can be configured to cooperate with both the proximal and distal annular portions of the sealing flange. The provision of a coating on the sealing contact surfaces of the pin and/or box ensures better adhesion of the seal devices in the housing.

In accordance with one embodiment, a threaded joint is provided. The threaded joint comprises a female tube comprising a box with internal female threads, where the box has a nose. The threaded joint also comprises a male tube comprising a pin with external male threads, the pin being adapted to be made-up in the box. A housing is defined between an external surface of the pin and an internal surface of the nose of the box. The joint further comprises a sealing flange comprising a first annular portion and a second annular portion, the first annual portion comprising an inner surface configured to contact the external surface of the pin and an outer surface configured to contact the internal surface of the nose of the box, the second annular portion configured to abut an end surface of the nose of the box. In some embodiments, the first annular portion is configured to be compressed between and in sealing engagement with the external surface of the pin and the internal surface of the nose of the box when the pin is made-up in the box. In some embodiments, the second annular portion is configured to protrude from the housing when the pin is made-up in the box.

In accordance with another embodiment, a joint is provided comprising a threaded box having a distal nose, the threaded box configured to couple to a threaded pin. The joint further comprises a sealing ring comprising a first portion and a second portion. The first portion is positionable between the pin and the box, the first portion having an interior surface configured to sealingly contact the pin and an exterior surface configured to sealingly contact the box. The second portion is configured to protrude distally from the distal nose of the box and to provide an indicator of the positioning of the sealing ring.

In accordance with still another embodiment, a method of sealing a joint is provided. The method comprises installing a sealing flange onto a threaded pin such that an internal radial surface of the sealing flange contacts a non-threaded section of the pin at a location distal to a threaded section of the pin, the sealing flange comprising a first annular portion and a second annular portion. The method also comprises inserting the pin into a threaded box such that the first annual portion of the sealing flange is radially compressed between the pin and the box and the second annular portion of the sealing flange abuts an end surface of a nose of the box and at least a part of the second annual portion remains visible to a person observing the joint.

### BRIEF DESCRIPTION OF THE DRAWINGS

The foregoing and other objects will become more readily apparent by referring to the following detailed description and the appended drawings, in which:

FIG. 1 shows a section view on a longitudinal axial plane of an embodiment of a joint;

FIG. 2 shows an enlarged sectional view on a longitudinal axial plane of a sealing flange usable in the joint of FIG. 1;

FIG. 3 shows an enlarged sectional view on a longitudinal axial plane of another embodiment of a sealing flange usable in the joint of FIG. 1;

FIG. 4 shows an enlarged sectional view on a longitudinal axial plane of still another embodiment of a sealing flange usable in the joint of FIG. 1;

FIG. 5 shows an enlargement of the portion indicated with X of FIG. 4;

FIG. 6 shows an enlargement of the portion indicated with Y of FIG. 4.

### DETAILED DESCRIPTION

With particular reference to the indicated figures, there is shown a threaded joint indicated globally with reference numeral 1, connecting two tubes, a male tube or pin 3 with an external nominal diameter D, and a female tube or box 2 of external diameter D1, e.g., a coupling, or a box, more generally. The tubes can be made of, for example, high strength steel or alloy steel.

The pin 3 has a threaded portion 8 with male threads of appropriate profile, e.g., trapezoidal, whereas the coupling 2 has an internal threaded portion 7 with female thread mating with the male threading of the pin 3. The common axis of the tubes, pin 3 and box 2, is indicated with A.

The portion of the box 2 close to its nose 9 has an internal non-threaded surface 11. This surface 11 is at a pre-determined radial distance from an outer surface 12 of the pin 3 leaving an annular space therebetween that is sufficient to accommodate an elastomeric annular sealing flange 4.

Advantageously, but not necessarily, a housing 10 in the shape of an annular groove is defined on the internal surface 11 of the box 2 between the end of the thread 7 and the box nose 9. This housing 10 can be configured to accommodate the sealing flange 4. The housing 10 can have a cylindrical surface, but can also or alternatively can have a frusto-conical surface with a slight taper (e.g., ranging from about 2% to about 6%) towards the threading 7 of box 2.

The sealing flange 4 has a body which can include two main annular portions. A first annular portion 6, when mounted on the joint 1, is distal in respect to the box threading 7 and remains outside the space comprised between the pin 3 and box 2. A second annular portion 5 is proximal to the box threading 7 and can remain internal to the space between the pin 3 and box 2 (e.g., in the annular space). The first 6 and the second 5 annular portions can, in some embodiments, be integral one to each other, and made in one piece of material, and give a substantially L-shaped section to the sealing flange 4 when observed on an axial section plane.

In operation, the sealing flange 4 is inserted on the pin external surface 12, at a point close to the place where the housing 10 will locate after make-up is completed. After the joint is made up close to the final positioning of the pin 3 in the box 2, the nose 9 of the box 2 will engage the second annular portion 5 of the sealing flange 4 so that the portion 5 enters into the housing 10 and the peripheral surfaces of the housing 10 will elastically compress surfaces 15 and 16 (FIG. 2) of the portion 5, producing an enhanced sealing effect since the nominal distance between external and internal surfaces 15 and 16 of the flange 4 (in the radial direction), in unloaded position is larger than the radial distance of the housing 10 between the surfaces 11 and 12.

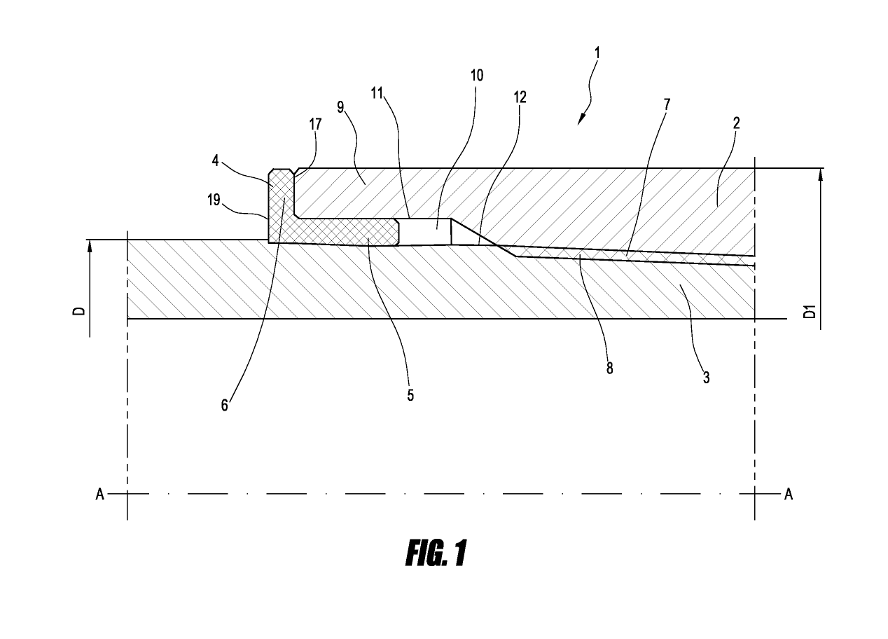

Progressing further with the make-up operation of the joint 1, the end surface 17 of the box nose 9 enters in contact with the surface 13 (FIG. 2) of the annular portion 6 of the sealing flange 4 and displaces the whole sealing flange 4 along the pin external surface 12 until make-up is completed, e.g., when the abutment shoulders provided in the joint (not shown in the figures, as they generally are designed outside the joint portion to which FIG. 1 refers) arrive in contact.

Since surface 14 (FIG. 2) of the annular portion 6 of the sealing flange 4 remains always in sight of the operator during the whole make-up operation of the joint 1 it is advantageously possible to check whether the sealing flange 4 is misplaced during the operation. Moreover, the contact between the surface 13 of the sealing flange 4 and the end surface 17 of the box nose 9 ensures a good positioning of the sealing flange 4 in the housing 10.

The first (front or external) portion 6 of the sealing flange 4 contributes also to further increasing the sealing function since the external fluid pressure acts on the external surface 14 of the flange 4 which remains outside the housing 10 and deforms itself to stick against the surfaces 11 and 12 and adjacent to it.

Several, non limitative, embodiments are provided for the sealing flange 4 which are shown in particular in the FIGS. 2 to 6, which show various shapes for the second annular portion 5 of the sealing flange 4.

The embodiment of FIG. 2 provides for an annular portion 5 further divided into a first sub-portion 5′, which has annular external and internal surfaces parallel to each other, and a second sub-portion 5″, which has external and internal surfaces convergent towards each other by an angle δ of small value, generally comprised in the range from about 1° to about 10°, the second sub-portion 5″ tapering towards the first portion 6 of the sealing flange 4.

The embodiment of FIG. 3 has a basic structure like the one of FIG. 2 and additionally has externally a coaxial annular protrusion 18, which has a length B in section at the base of the protrusion 18 comprised in the range from about 0.5 mm to about 3 mm and of appropriate radial dimension to produce sufficient additional sealing capacity.

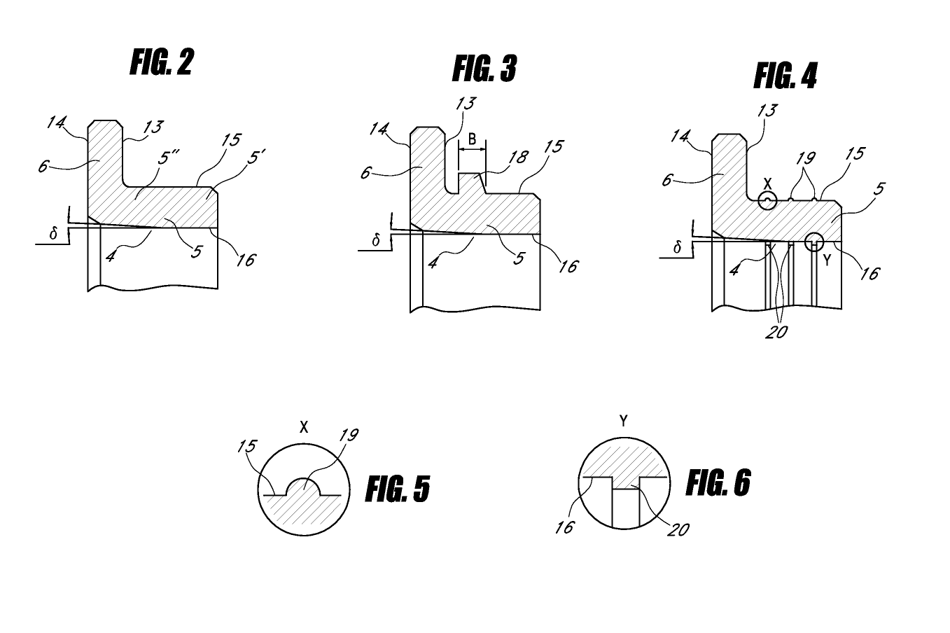

The embodiment of the sealing flange 4 shown in FIG. 4 has a plurality of smaller annular protrusions 19 on the external surface 15 of the sealing flange 4 and for several small annular protrusions 20 on the internal surface 16 of the sealing flange 4. The radial dimensions of all protrusions can be appropriately chosen to provide the desired sealing capacity to the flange 4.

The annular protrusions 19 of the external surface 15 of the embodiment of FIG. 4 are shown in an axial section in an enlarged view in FIG. 5. The annular protrusions 20 of the internal surface 16 are shown in an enlarged view in FIG. 6. It is appreciated by a person skilled in the art that the sectional shapes of the annular protrusions 19 and 20 shown in FIGS. 5 and 6 can be inverted and the shape indicated for the external protrusions can be used for the protrusions of the internal protrusions and vice-versa Likewise both protrusions used on the external surface or on the internal surface of the sealing flange 4 can include other shapes or can be made with the same sectional shape. This embodiment is not shown in the figures.

These protuberances 18, 19, 20 improve sealing effectiveness of the whole sealing flange 4 and behave as multiple small O-rings, contributing further to improve tightness between sealing flange 4 and the interior surface 11 of the box 2 and external surface 12 of the pin 3.

The sealing flange 4 can be made of various elastomeric/polymeric materials, e.g., polytetrafluoroethylene (PTFE) charged with, e.g., fiberglass; graphite; MoS02; etc. The sealing flange can be made of other suitable materials (e.g., other compressible and/or resilient materials).

The joint 1 defines an inner duct, containing the axis A of the pin 3 and box 2, in which a fluid, for example a hydrocarbon, such as natural gas, petroleum, or other similar fluid, flows and an outside, which can be in contact with fluids of various kinds, such as sea water in specific applications. The sealing flange 4 advantageously offers an additional sealing capacity to the joint 1 which prevents external fluids present outside the joint 1 from flowing into the interstices of the threads 7, 8 of the joint 1.

The method of mounting the joint 1 with the sealing flange 4 is as follows. Prior to the make-up of the connection, the sealing flange 4 is pre-mounted onto the pin 3 beyond the threaded portion 8 and placed on an unthreaded portion of the outer surface 12. The following step provides for the make-up of the pin 3 and box 2, during which there may occur a turning around the axis A of the sealing flange 4, which is already in place before inserting the pin 3 in the box 2, the turning caused by the friction contact of the flange 4 with the internal surface 11 of the housing 10. The fact that the flange 4 is already in place on a non-threaded portion of the pin 3 avoids damage of the sealing flange 4, which is an advantage in respect to the case when a sealing ring has a contact on its internal surface with the pin threaded portion. Moreover when the make-up operation of the joint comes closer to the end, the sealing flange 4 is also slightly pushed by the abutment 17 of the box nose 9 on the surface 13 to its final position. In this last part of the make-up, the sealing flange 4 is pushed against the final rest surface, thereby gradually further increasing adherence of the sealing flange 4 on the pin 3 in the housing 10. After the sealing flange 4 enters into the housing 10 on the box 2, the flange 4 does not slide anymore in an axial direction, although in some cases when the joint has reached the final level of make-up the flange 4 slides slightly only in a direction around the joint axis A, under either internal or external pressures, but remains restrained by the walls of the housing 10 and substantially motionless.

When the joint 1 has reached its final made-up position, e.g., because the abutment shoulders of the pin 3 and box 2 have reached their mutual contact, the sealing flange 4 assumes its final geometry and reaches its final design stresses and deformations.

The sealing flange 4 gives the threaded joint 1 also the advantage of a capability to offer successive barriers to leaks.

The joint 1 may also have an internal metal-to-metal seal near the nose of the pin 3. This embodiment is not shown in the figures as this portion of the joint 1 is not illustrated.

Optimal sizes of the flange 4 are:

Internal diameter (ID): as per the pin D4 diameter;

Wall thickness of the portion 5 (Wt): under coupling: from about 2 mm to about 8 mm;

Outer diameter of portion 6 (OD): generally the same diameter as the connection OD.

The joint 1 can be used in, for example, the field of oil country tubular goods (OCTG) and pipeline connections for the oil and gas industry, especially in offshore applications.

Although the foregoing description has shown, described, and pointed out the fundamental novel features of the present teachings, it will be understood that various omissions, substitutions, and changes in the form of the detail of the apparatus as illustrated, as well as the uses thereof, may be made by those skilled in the art, without departing from the scope of the present teachings. Consequently, the scope of the present teachings should not be limited to the foregoing discussion, but should be defined by the appended claims.

What is claimed is:

1. A threaded joint, comprising:
a female tube comprising a box with internal female threads, the box having a nose;
a male tube comprising a pin with external male threads, the pin being adapted to be made-up in the box;
a housing defined between an external surface of the pin and an internal surface of the nose of the box; and
a sealing flange comprising a first annular portion and a second annular portion, the first annual portion comprising an inner surface configured to contact the external surface of the pin and an outer surface configured to contact the internal surface of the nose of the box, the second annular portion configured to abut an end surface of the nose of the box,
wherein the first annular portion is configured to be compressed between and in sealing engagement with the external surface of the pin and the internal surface of the nose of the box when the pin is made-up in the box, and wherein the second annular portion is configured to protrude from the housing when the pin is made-up in the box.

2. The threaded joint of claim 1, wherein the sealing flange has an L-shaped cross-section.

3. The threaded joint of claim 2, wherein the outer surface of the first annular portion further comprises an annular protrusion configured to contact the internal surface of the nose of the box.

4. The threaded joint of claim 3, wherein the inner surface of the first annular portion further comprises an annular protrusion configured to contact the external surface of the pin.

5. The threaded joint of claim 1, wherein the inner surface of the first annular portion tapers with respect to the outer surface of the first annular portion.

6. The threaded joint of claim 5, wherein the taper is about 1° to about 10°.

7. The threaded joint of claim 1, wherein the first annular portion and the second annular portion are monolithic.

8. The threaded joint of claim 1, wherein the sealing flange comprises an elastomeric material.

9. The threaded joint of claim 1, wherein the housing comprises an annular space between the external surface of the pin and the internal surface of the nose of the box.

10. A joint, comprising:
a threaded box having a distal nose, the threaded box configured to couple to a threaded pin; and
a sealing ring comprising a first portion and a second portion, the first portion positionable between the pin and the box, the first portion having an interior surface configured to sealingly contact the pin and an exterior surface configured to sealingly contact the box, the second portion configured to protrude distally from the distal nose of the box and to provide an indicator of the positioning of the sealing ring.

11. The joint of claim 10, wherein the sealing ring has an L-shaped cross-section.

12. The joint of claim 10, wherein the exterior surface of the first portion further comprises an annular protrusion configured to contact the box.

13. The joint of claim 10, wherein the interior surface of the first portion further comprises an annular protrusion configured to contact the pin.

14. The joint of claim 10, wherein the interior surface of the first portion tapers with respect to the exterior surface of the first portion.

15. A method of sealing a joint, comprising the steps of:
installing a sealing flange onto a threaded pin such that an internal radial surface of the sealing flange contacts a non-threaded section of the pin at a location distal to a threaded section of the pin, the sealing flange comprising a first annular portion and a second annular portion; and
inserting the pin into a threaded box such that the first annual portion of the sealing flange is radially compressed between the pin and the box and the second annular portion of the sealing flange abuts an end surface of a nose of the box and at least a part of the second annual portion remains visible to a person observing the joint.

16. The method of claim 15, wherein the part of the second annual portion that remains visible indicates the sealing flange position.

17. The method of claim 15, wherein the sealing flange moves axially relative to the pin in the course of the inserting step.

18. The method of claim 15, wherein the sealing flange has an L-shaped cross-section.

19. The method of claim 15, wherein the first annular portion further comprises an annular protrusion configured to contact the pin or box.

20. The method of claim 15, wherein the sealing flange further comprises an external radial surface and the internal radial surface tapers with respect to the external radial surface.
